(19) United States
(12) Patent Application Publication
(10) Pub. No.: US 2012/0330810 A1
(43) Pub. Date: Dec. 27, 2012

(54) Method and System for Real Estate Exchange and Investment

(76) Inventor: Sandip Dadkar, Pune (IN)

(21) Appl. No.: 13/294,404

(22) Filed: Nov. 11, 2011

(30) Foreign Application Priority Data
Jun. 22, 2011 (IN) 1816/MUM/2011

(51) Int. Cl. G06Q 40/00; G06Q 10/00

(52) U.S. Cl. 705/37; 705/306

(57) ABSTRACT

The present invention includes methods and systems of monetizing appreciation and improving fungibility of real property assets. Some embodiments of the present invention provide a method and system for establishing real estate units (RU) representative of the value of real property assets. The system includes a central server accessible via a network having a processor, software, random memory, and data storage hardware. The data storage hardware stores a database having data pertaining to a plurality of real estate assets and transforms the data to unitize real estate units reflective of the value by classifying the real estate assets into asset classes. Transformed data includes a saleable area of each property and an initial price for the real estate units based on the asset classes and saleable area. Accordingly, the server enables trading of the real estate units via the network.

### TECHNICAL FIELD

This disclosure generally relates to real estate valuation and exchange, and more particularly to establishing a standardized valuation and trading methodology for real estate based on particular characteristics of the real estate to create investment opportunities.

### BACKGROUND OF THE INVENTION

Real estate, globally, is an important and sought after investment. Real estate prices are typically driven by the economics of simple supply and demand economics. However there are often distortions of this economic principal, which have limited the availability of real estate as a universal investment tool. Current real estate markets lack fluidity when compared to markets for securities and other investments.

Fluidity in real estate markets is inhibited by investment thresholds, extensive documentation, historic evolution of the attendant legal framework, the cost of financing and the time required for closing any real estate deal.

While the current legal framework that has evolved to retain social order and minimize ownership disputes, it is not ideal from an investor standpoint. In particular, investors that are accustom to trading in commodities, stocks and derivatives view investments based on financial considerations including risk, appreciation and dividend potential. Most investors are accustom to quantifying risk, so optimal financial investments provide ways of hedging risk and allowing for a predictable means of fungibility, which is important when risk factors change. Investors are also interested in capitalizing on appreciation of their investments, as well as an annual return.

Many investors have restricted their investment choices to non-real estate assets due to an inability, or difficulty, in achieving portfolio diversification, monetization of appreciation in a desired time frame, burdens of transaction costs, and an inherent inability of the free market system to continually reflect actual values in real time.

In the current investment climate, the investment horizon is typically medium to long term involving substantial documentation and transaction cost. The current real estate market lacks basic institutional framework with transparent rules and standardized procedures. This often restricts capital formation and mobility, particularly in a world-wide investment setting. This situation, combined with evolving mortgage rules, increases the concentrated developments in less-than-optimal regions along with the possibility of an asset bubble.

What is desired is a way of monetizing appreciation of real estate assets that is guided by market principals at relatively low transaction costs and which is simple, rapid and predictable. What is also desired is a way of investing in real estate assets that does not involve financing, exchange of title, traditional encumbrances, and where the value of assets is determined by market principals.

### SUMMARY OF THE INVENTION

The present invention includes a Real Exchange (RealEX) that segregates the economic interest of real estate assets from its ownership interest and converts the economic interest into real estate units (RU's) which can be issued to multiple investors. These RU's are fully fungible and may be held and traded privately or via an open exchange. The real estate asset owner shares the economic interest of the asset with the investor at fixed pre-determined rate. Real estate units can be issued for closed ended or open ended. RU's can be settled against actual delivery of under lying real estate assets, or for cash, or for units of other real estate class. RU's can be foreclosed by the issuer by settling the same for cash. The re-purchasing of RU's preferably occurs at face value in accordance with terms associated with the RU and not at market rate.

The RealEx separates ownership of economic benefits of real estate assets from its legal ownership and facilitates the sharing of economic ownership among set of investors on certain terms and conditions in a controlled environment. The RealEx structure helps numerous investors to participate in an economic growth of a real estate assets based on their investment capabilities and risk appetite without legally owning the assets which otherwise require substantial funds or financing, which may be beyond the limits of many investors.

The present invention transforms available data pertaining to real estate assets to create real estate units reflective of the value of the real estate assets. Particular methods steps include programming a general purpose computer, which functions as a central server, to recognize the real estate asset type for each real estate asset, classify the real estate asset according to use, unitize the real estate asset as real estate units, and valuate the real estate units to establish an initial offering price. The central server also executes these steps.

The step of recognizing a real estate asset type includes determining whether the real estate asset is land, constructed property, or unconstructed property. The step of classifying the real estate asset includes determining the use as industrial, residential, agricultural or commercial. The step of unitizing the real estate asset establishes real estate units based on pre-determined criterion. Typically the pre-determined criterion includes zoning or other applicable government regulation or policy. The pre-determined criterion includes a holding period of the real estate units, the cost of capital, and applicable inflationary trends affecting value.

In accordance to another embodiment of the present invention, the step of categorizing the property into asset classes includes identifying the property as being in a particular region, district, or state. Geographic location of the property often affects the valuation of an underlying property.

In accordance to another embodiment of the present invention, the step of establishing multiple sub-classes include identifying the property based on a minimum criterion. Depending on the risk adverse of an investor and the demand for specific properties, establishing a minimum criterion affords more opportunity for investors. For example, the minimum criterion for certain RU's may be 20,000 square feet while for others the minimum is set at 1200 square feet.

In accordance to another embodiment of the present invention, the step of determining related government policy includes grading the property based on industry zoning with different levels of incentives.

### BRIEF DESCRIPTION OF THE DRAWINGS

FIG. 1 illustrates a RealEx system for trading RU's.

FIG. 2 shows a flow diagram for unitization and valuation of real estate assets.

FIG. 3 shows a flow diagram showing the utilization and transformation of data utilized by methods of the present invention.

FIG. 4 shows a flow diagram in accordance with the present invention.

FIG. 5 shows a flow diagram in accordance with an embodiment of the present invention.

### DETAILED DESCRIPTION

The present invention relies on traditional real property valuation methods for creating and establishing an initial value for real estate units (RU's). The present invention introduces the benefit of utilizing free market mechanisms to adapt the value of any real property asset, or class of assets in real time through the use of the RU's. The present invention adds additional benefits including improved fungibility, and lower transaction costs to enable investors to be more readily involved in real property as an investment tool. For a property owner, one benefit of utilizing RU's as proposed by the present invention enables the owner to readily extract value from an appreciated asset.

### Real Property Value

Real property assets differ in location, and most differ in configuration. Complexity in real property valuation arises from the heterogeneous nature of particular properties, and as an investment class. Location is one of the most important determinants of value. The absence of a true market-based pricing mechanism often mandates the need for an expert appraisal of real property, which results in an estimated value range. This adds to transaction costs and time for consummating a transaction.

A Walrasian Auction, such as used for trading corporate stock, is proposed as one aspect of the present invention. Thus, after an initial value is set, and RU's are established to reflect a present value of real property assets, the market then determines the value of the RU's for trading, redemption and investment purposes. There are several ways of valuating real property. Some of the most common ways utilize Market Value, Value-in-use, Investment Value, Insurable Value and Liquidation Value.

Market Value is the actual price at which an asset would trade in a competitive Walrasian Auction setting. According to International Valuation Standards (IVS) Market Value is the estimated amount for which a property should exchange on the date of valuation between an educated buyer and a seller in an arms-length transaction where the parties act knowledgeably, prudently, and without undue influence. The present invention provides a way of achieving the true Market Value of an asset, not just an estimate.

Value-in-Use is the net present value (NPV) of a cash flow that an asset generates under current ownership and specific use. Value-in-use is the value to one particular user, and may be above or below the Market Value of a property. Value-in-Use changes depending on the use that the current owner derives from the property.

Investment Value is the value to a particular investor, and is often higher than the market value of a property. Investment Value thus varies as between particular investors.

Insurable Value is the value of real property calculated by an insurer and covered by an insurance policy. Generally it does not include the site value, but only the value of improvements to the site. Accordingly, Insurable Value is typically less than the Market Value. Insurable Value depends on the terms of any insurance policy, and may vary as between insurers.

Liquidation Value is calculated as the value under forced or orderly liquidation. This is commonly used when the property is included in a bankruptcy or insolvency proceeding. It assumes a seller is compelled to sell in a relatively short exposure period which is less than the market-normal sales cycle. In sum, the Liquidation Value is the value associated with sale of real property in an abnormally short amount of time. Liquidation Value may change significantly depending on the term of the liquidation process.

It is important to distinguish between Value and Price. A price obtained for a specific property under a specific transaction may or may not represent that property's value, under any of the various valuation methods. Special considerations may be present. Such considerations may include a special relationship between the buyer and the seller, or the unique character of the property. For example, the transaction may be part of a larger set of transactions in which the parties had engaged.

Another possibility creating disparity between value and price is that a particular buyer may be willing to pay a premium over and above the estimated Market Value, if his subjective valuation of the property is higher than the Market Value. An example of this would be the owner of a neighboring property who, by combining his own property with the subject property, could thereby obtain a benefit that no other could obtain, for example economies-of-scale may determine that the value to a neighboring land owner may be higher than for any other investor. Similar situations often arise in corporate finance, as for example when a merger or acquisition is concluded at a price which is higher than the value represented by the price of the underlying stock. Such situations are not uncommon in real estate/property markets.

### Valuation Approaches

There are a number of approaches to asset valuation typically include the Cost Approach, the Comparative Approach, Residual Approach and the Income Approach. Many choose to analyze all approaches, and give weight to particular approaches that are most suitable, depending on the available of quantitative-data to support the chosen approach and the interest of the parties to the transaction. The cost approach, in essence, reflects the cost of reproducing an asset. The sales comparison approach measures value base on transactions involving similar assets. The residual approach looks to the potential for underdeveloped property to become fully developed in an economic sense. The income approach measures current income derived from an asset and then modifies the value based on probable revenue multipliers.

The real estate exchange of the present invention and the development of real estate units (RU's) are based on separation of ownership of economic interest verses legal ownership.

Currently legal ownership is the primary basis of generating income for its owner, a lessee, or an investor. The present invention particularly emphasizes the importance of economic interests and sharing the economic interest among investor either for fixed period of time or on perpetual period. At least a portion of the economic interest is shared among the property owner with any number of investors. A regulated but transparent exchange enables capital mobility among investors and creates investment opportunities which suit the investment and the risk appetite of the investor. A regulated but transparent exchange also provides a way for the property owner to extract value from appreciation of the underlying property. A collateral benefit is to stimulate economic activity in real estate markets.

The Real Estate Exchange (RealEx) aspect of the present invention establishes an independent exchange for trading of units of economic value based on underlying class of real estate assets. Each real estate asset owner follows unified norms for conceptualization of real estate units and issues them on exchange to public.

The administrative mechanism of RealEx includes Regional level Certifying Authorities (RCA) and Central Regulatory authorities along with multiple players including merchant bankers, RTA, assets appraisers etc. RU's may be either open ended or closed ended. Derivatives are possible, including options. For example, one embodiment of the invention includes providing a contractual option of converting RU's into ownership of underlying assets, or cash, or exchange for real estate units (RU's) of alternate properties having varied asset classes.

Multiple variables affect the prices of units after an initial offering. Such pricing may initially be structured according to a particular valuation methodology, or be relatively arbitrary. After an initial offering, RU valuation is free to change with market conditions, use and other factors. Ideally, where RU's are traded on an open exchange the RU valuation reflects the true Market Value of the relevant real estate assets in real-time. Market Value of the property is proportional to the price paid for the RU's and the sum of the RU's should reflect the Market Value where the full value of the real estate assets are converted to RU's.

Closed ended units may be settled for transfer of legal ownership of underlying assets or by cash to an RU holder by a developer. The asset owner may give an option to the investor to take units of another property in same or different assets class based on new or existing terms.

The RealEx enables real estate asset owners raise capital at affordable cost without diluting legal ownership. The exchange enables investors to participate in appreciation of any real estate assets class without making substantial investment. An investor can also minimize risk of tedious documentation and variable transaction costs and timing associated with title-based real estate transactions. Investors can invest in stages with multiple objectives and benefits from price cycle by trading. The RealEx has beneficial economic consequences by creating one more source of capital formation and capital mobility, thus unlocking the value of otherwise “dead” real estate investments. In particular, any appreciation of a real estate asset can readily be monetized without exchanging title or use of the asset and without borrowing directly against the asset.

The RealEx creates a database of real estate properties which is transparent and standardized, this helps in avoiding a real estate bubble which could, and has at times, crippled the fluidity of a real estate market. Additionally RU's may be purchased by those individuals and entities having weak credit, thus introducing additional investors into the potential pool of possible investors. Government incentives may be applied to further development in regions, or industries, strategically important for the government. For example, government incentives may be offered for particular regions lacking economic stability or growth.

RealEx allows remote individual and institutional investors from most any country or region to participate in the investment process. Since investors desire require reliable and current quantitative data pertaining to real estate properties, a transparent and a regulated environment could assure fair pricing, settlement etc., with standard and minimal documentation and the lowest possible transaction cost.

A property developer may wish to develop a pool of potential buyers at an early stage of property development with minimum commitments at the lowest possible cost. Other investors may wish to have short term exposure in a real estate asset, or class of assets, without making a large investment or becoming burdened by tedious documentation. Other investors may wish to take advantage of low prices of real estate assets by owning smallest possible portion of real estate without any large scale commitment in future. RealEx satisfies these investor demands.

Some owners that require ownership and possession of real estate may wish to accumulate lowest possible interest in the real estate asset to free capital can for operations, and inventory. Investors who desire to acquire title may have sufficient capital to invest over the period of time with an intention to convert the investment into an ownership interest, which can be monetized when the asset appreciates, or transferred if the Investor's needs change. This is enabled by the present invention without requiring a firm commitment, such as under a real estate sales contract, and without paying interest to a lender.

Real estate typically includes various types of land including agricultural, industrial, residential, and multi-use. Real estate also includes incomplete construction of any kind.

For an individual, the real estate investment continues to remain an important investment asset which may function as a substitute or supplement stock, bond, commodity and other investments. It can also substitute or supplement pension, life insurance and other provident funds.

In spite of regulatory policies and huge demand-supply gap, real estate has not yet graduated into transparent model to have seamless movement of capital and provide an opportunity for participant to make short to medium term profits. The current structure of real estate industry often requires compulsory ownership of asset by an investor with holding period of medium to long term. The structure does not offer optimal opportunities to ride on speculation or to defeat the possibility of bubble. Absence of such mechanism misguides the uninformed investor and exposes them to risk without optimal exit opportunities.

Securities created out of real estate would not be a mortgage backed securities which are already in existence but would be a step further by trade of actual real estate units creating an investment position for an investor in underlying assets class at lowest possible level without actually owning it. To the extent of understanding, it can be called as a derivative position taken by an investor for a current or prospective real estate asset available for ownership. It will be a relationship between a real estate owner and investor or between multiple investors for an asset owned by a third person. The Exchange would create an investor class having interest in current and future growth prospect of real estate assets, in phased manner, without making significant capital commitments and the same time keeping the flexibility.

RealEx functions on the principal of collective ownership. The interest in underlying real estate class is collectively owned by a large number of investors whereas the legal ownership remains with the asset owner. The administrative mechanism running the exchange ensures that the collective ownership is safeguarded and developed in transparent manner.

The present invention includes unitization, which creates a common unit for a particular type of real estate class. Unitization includes having a common denominator per class of asset which will be traded on exchange representing the economic benefits connected therewith. Unitization, in one embodiment, includes broad classifications such as vacant land—industrial, residential, commercial, agricultural; constructed property—industrial, residential, commercial; and TDR (Transferable Development Rights, allotted by municipal corporations to contractor for a price and terms) residential and commercial. Each unitized class has an investment potential and almost all types address investment horizon of every investor. Unitization of real estate utilizes standardization of evaluation parameters.

Unitization of asset classes preferably is common across any particular region having the same legal regulatory framework. This will not only facilitate to have uniform measurement unit but also fix the investment value per unit for trade.

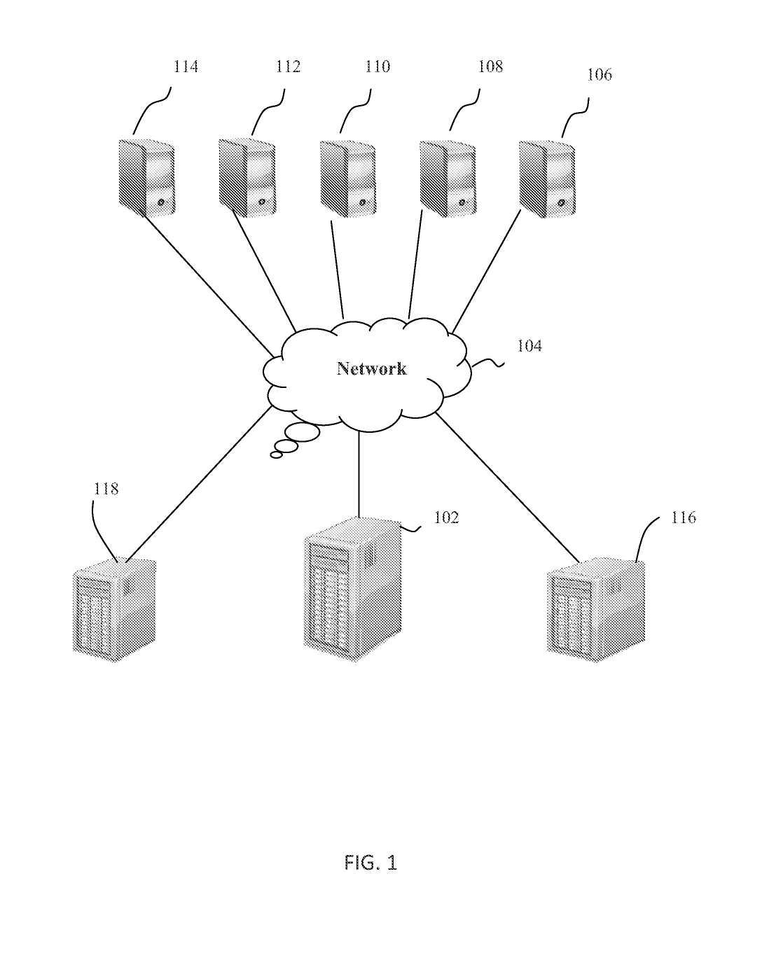

FIG. 1 illustrates a system for creating and trading RU's. The system includes a central database server 102, which is general purpose computer. The server 102 is in communication with the network 104, which includes Internet. The invention also includes regional servers 116 and 118, which improve performance and reliability of the system. The system also includes investor stations 106, 108, 110, 112 and 114, which are computer workstations in selective communication with the servers 102, 116 and 118 via the network 104.

The central database server 102 includes a processor, software, random memory, and data storage hardware. The software provides the server 102 instructions to execute the methods of the present invention. The data storage hardware stores a database having data pertaining to a plurality of real estate assets and transforms the data to unitize real estate units reflective of the value by classifying the real estate assets into asset classes.

The investor stations 106-114 access the central database server 102 to trade RU's that are stored on the central database server 102. The investor stations 106-114 are capable of dispatching orders for RU's to enable the RU's to be traded. Trading includes purchasing, selling, exchanging, or settling RU's in accordance with the present invention. The central database server 102 publishes pricing and availability of the RU's via the network 104, and any other data and information useful for the trading of RU's.

The regional servers 116 and 118 include a processor, software, random memory, and data storage hardware. The software provides the server 102 instructions to execute the methods of the present invention and to enable redundancy with the central database server 102.

RealEx has a structure which is easy to understand, access and easy to reach-out. The structure is in online format, administered centrally along with flexibility of local flavor to interpret the RU's and facilitate trading. The trading mechanism preferably is universal, whereas the understanding, validating and conversion should have flexibility for localization. Localization can be at any extent and could be a city/district/state based on the diversity and/or concentration of RU's listed on an exchange.

The proposed administrative mechanism may mirror current regulatory schemes devised in international securities markets. However it would have an additional layer of certifying and validating agencies for each region having differing regulatory frameworks. These agencies function based on common rules and regulations and keep an eye on the pricing of RU traded on RealEx relating to real assets of its designated region. The central regulatory authority would act as controlling body acting in similar manner for the country in addition to ensuring the discipline in functioning of all participants in the RealEx. The central authority would frame the rules of the exchange and works towards simplification, standardization and development of market.

RealEx Certifying Authority (RCA) would be first level authority responsible for implementation and regulation of state/area/district exchange. The ‘seller’ would register his RU for trading and ‘buyers’ would register themselves for initiating any trade. Each stage of operations would follow uniform procedure code followed across RCA in the country. There could be some exceptional regulations towards converting (buying and selling) the RU into actual property.

The objective is to reduce the administrative hurdles to minimal by merging or eliminating the RCA over the period of time once the market gets matured and standardization, categorization filtered down and understood well by all participants. RCA's responsibility includes a care taker role for unit holders and ensures involvement at every stage of RU. RCA should also safeguard interest of developer, in case an investor refuses to surrender the closed ended units and refuses to take possession of a property. RCA should ensure that local rules and regulations relating to owning an asset are adhered to by each constituent.

Buyers and Sellers of RU could be either the buyer/owner of the RU and could be any one or all of the followings: builders and developers who either own the RU or wants to have RU as part of their business operations; intermediaries like real estate agents, financiers, financial institutions having direct or indirect interest in real estate development; government agencies like authorities set up for rehabilitation of slum areas, industrial development authority's (MIDC), development agency, operates at state level, set up by government for industrial area development industrial parks etc.; corporate houses having huge land banks as part of their balance sheet, wants to unlock value of their assets without compromising its ownership; corporate, institutional investor, who would like to invest their funds in RU with/without objective of converting them into underlying assets class; and any other participant having interest in real estate assets.

In accordance with an embodiment of the present invention, the RealEx will function at two steps, one at country level and another at state/district level. The seller would list his RU at certified face value (FV) for sale. The face value would be based on broad valuation parameters specified by Central Authority. These FV added will be premium based on the demand-supply functions and ‘coupon rate’. The coupon rate would be interest rate payable by the seller to each buyer per annum. Typically the coupon rate would be a function of cost of capital and rental income enjoyed by the underlying assets class in a given Tier area. The seller would have option to delist his RU with or without any option of conversion into actual ownership. RU's with conversion option would have higher premiums attached as compare with RU without a conversion option. Each RU would have a minimum lock in period facilitating the seller to either create the underlying assets class along with requisite formalities for conversion or purchase of additional, new RU's from markets to hedge his positions.

RealEx would have a unique feature of conversion and/or settlement of RU whereby an investor would get the actual underlying assets from the issuer against the surrender of his RU. The conversion means getting actual property equivalent to the RU from the issuer. This is to be done at issue price and not the price the RU currently traded. The difference between these two would be the period cost born by the investor. The RCA would act as settlement bodies to ensure that the conversion happens smoothly and in compliance with local rules and regulation along with requisite documentation. There could be some areas/states, wherein the ownership of a real estate property is restricted, in such cases the conversion option cannot be exercised by the investor and the investor needs to opt for settlement option or sell the units in market at available rate, which should be near to sell rate of property.

Settlement of RU could be done either in cash or issue of fresh RU's. The fresh issue of RU's, in such cases, can be selective or be for public at large. In such cases it would be called as an exchange of RU's and not settlement. The exchange of RU's for existing RU's would be based on mutual consideration of investor and developer.

At the full blown phase of RealEx there are many benefits. A nationwide virtual market place for trading the RU is backed by assets from any remote corner of the country. The nationwide virtual market place will unlock the value of underlying assets class and provide an opportunity for every buyer and seller to win, trade in RU and indirectly own the real estate in phased manner, based on its investment and risk appetite without making huge capital investment in one property. An investor can distribute his investment in multiple RU of different Tier areas and thereby de-risk his investment. A common valuation and certification parameters followed across the country will bring the entire real estate properties of a country/state/district at one level which otherwise was not possible. The investor class is broadened by allowing investors from across the country to own the RU thereby creating required liquidity in real estate assets class which to date is only restricted to local investors. The entire structure of RealEx provides much desired sanity to real estate industry and therefore builds confidence among and corporate investor to diversify their investments and aggressively consider real estate as one of the investment avenues. The RCA would rate the ‘sellers, buyers’ and RU's thereby ensure standardization of the participants. This would help in sharing the risk of trade. The coupon rate would help the investors generate a source of income without making huge investment towards owning the assets. RealEx helps the sellers to raise the capital at fair rate without having to mortgage their assets at the same time developing their prospective buyers. Movement of RU from one buyer to another buyer is seamless with minimal documentation thereby bypassing the stringent regulations and T&M currently involved.

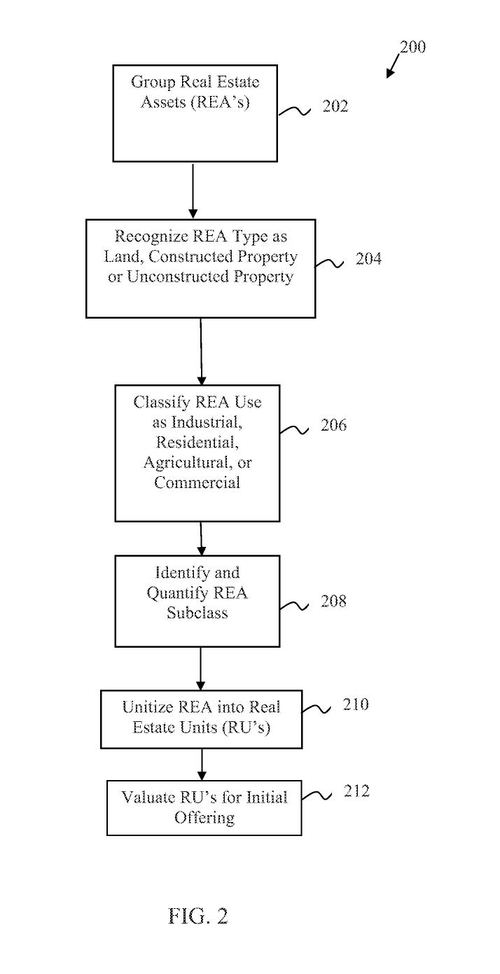

FIG. 2 shows a flow diagram 200 for unitization and valuation of Real Estate Assets (REA's). The flow diagram begins with step 202 of grouping REA's that will participate in the RealEx. Next step 104 recognizes and classifies the REA type as land, constructed property, or unconstructed property. Step 206 classifies the REA use as Industrial, residential or commercial. Step 208 identify and quantifies REA subclass. RU's to the real estate asset based on the determinations in step 104 and step 106. Step 210 unitizes REA's into Real Estate Units (RU's) to enable the RU's to be issued to investors. The step 212 valuates the RU's for an initial offering.

Unitization 210 of any given class and sub-class of asset relies on common economic features like area, i.e. dollar rate per sq. ft in the United States, cycle of development, region, use, and related government policies. These features vary for each class of assets, but should be clearly identified and understood by investors. Unitization 210 achieves a categorization of units in every asset class and may be associated with a particular region/district/state.

For example, RU's may have multiple classes with different level of completion where the property is under development and different age factors. RU class and sub-class assignment depends on such factors. RU establishment, including class and sub-class assignment also depends on the size of the underlying property asset, i.e. area. An RU class could be assigned for commercial properties having a minimum area, i.e. 10,000 square feet. Other RU classes could be assigned having a lesser area, or a greater minimum area.

These denominators could vary from one issuer to another and from one area to another area. This should facilitate the smallest investor to own small component of RU in posh locality which otherwise would be unavailable to that investor. At the initial stage these variables could vary from one region to another and come out with hundreds of RU types, which eventually can be settled down to a few for every type of asset class. Investor preferences can also narrow the RU types over the period of time.

The step 212 achieves an initial offering price, at which, the RU is traded in local/district level. Prices for trading an RU after issuance would be function of its Market Value.

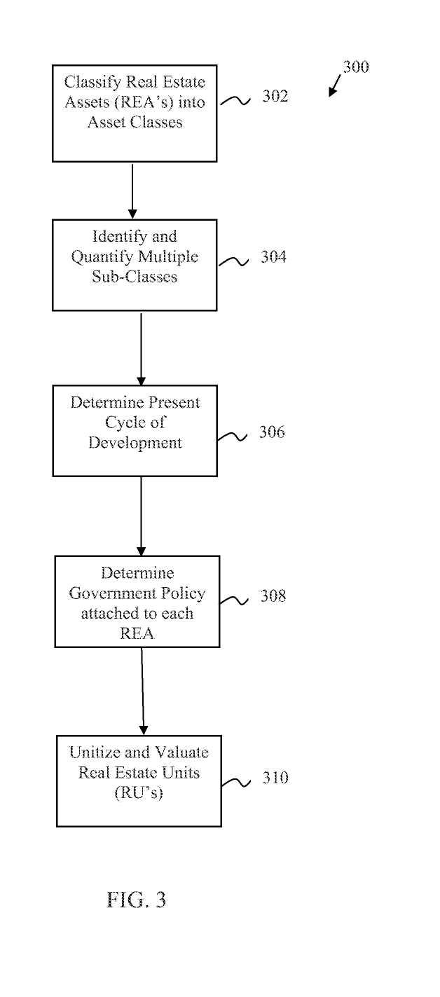

FIG. 3 shows a flow diagram 300 for valuating an RU for unitizing and valuating Real Estate Units (RU's) in accordance with an embodiment of the present invention. The flow diagram begins with step 302, which classifies Real Estate Units (REA's) into asset classes. Step 304 establishes multiple sub-classes. Sub-classes for REA's can include different level of completion (for properties under construction) and age factors, and numerous other attributes. In one embodiment, the sub-class is based on area of the underlying asset. Step 306 determines present cycle of development for the property, which affects the valuation of the RU. For example surrounding properties may be single family homes and the property being evaluated may be a multiple family structure or the property may be converted into a non-residential use such as a boarding house, hotel, spa or day-care facility. Step 308 determines any government policy attached to property. Zoning or other restricted use which may cause deviations in the property RU valuation. The flow diagram 300 ends with step 310 which unitizes and valuates the RU, which establishes a price for the RU's based on the previous method steps, and other factors. The pricing of the initial offering takes into account of the above factors.

Pricing at an optimal level increasing the trader and investor base by making incremental investment affordable to most investors. The true test of RealEx is to have trading of RU from almost every region of the country and same is traded at fair and transparent pricing. The pricing model needs to be based on objective parameters set up by an expert committee and which should be self evolving once listed. Key stages of RU once the RU's are standardized and categorized for trading on RealEx are independent certification and grading of RU, issuer, categorization of RU's, whether open ended or closed ended, and periodical validation of pricing, and determining the ‘conversion rate’ or delisting mechanism.

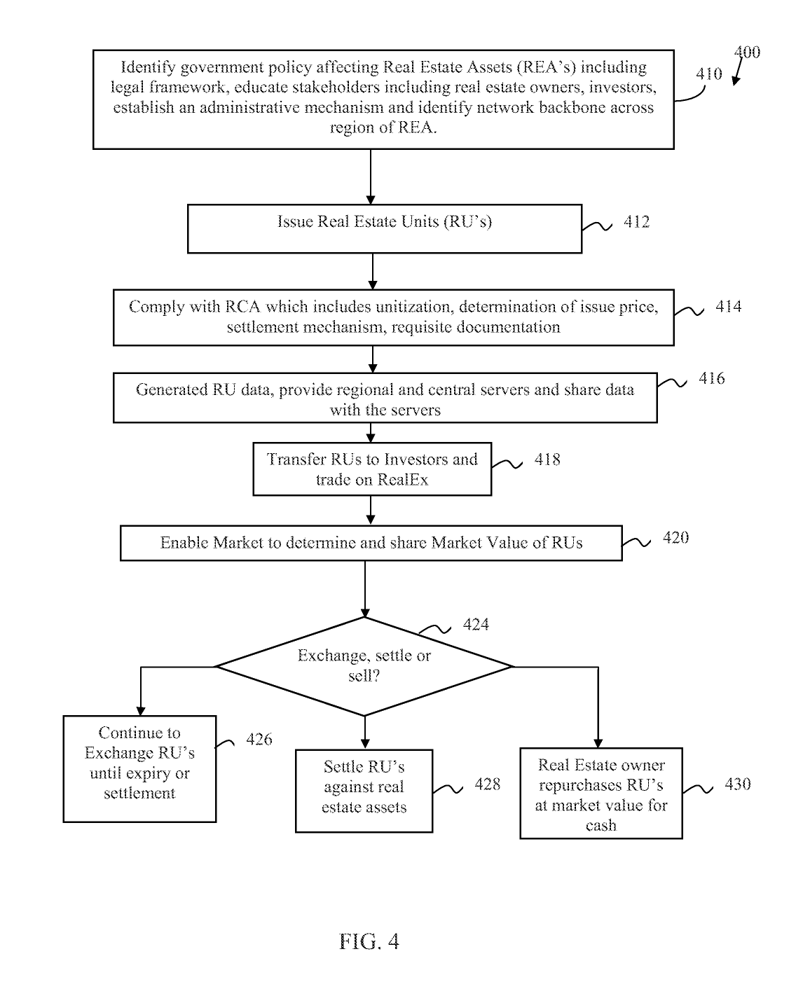

FIG. 4 shows a flow diagram 400. The flow diagram 400 begins with step 410 of identifying any government policy affecting Real Estate Assets (REA's) including legal framework, zoning, use restrictions and transfer restrictions. The step 410 includes educating stakeholders including real estate owners, investors, establish an administrative mechanism and identify network backbone protocols across regions of the situs of the REA.

In accordance with one an embodiment of the present invention, the participants in RealEx will be owners of Real estate assets (corporate, non-corporate), regional certifying authorities, merchant bankers, consultants coordinating for IPO, FPO settlement, conversions, etc., registrar and transfer agents, and investors. The list is modifiable based on evolvement of new format and introduction of new set of rules and regulations by the central and/or regional certifying authority. In step 412, a real estate owner decides to issue real estate assets in RU's and the database server stores data pertaining to the REA and the RU's. One goal of the real estate owner is to monetize any appreciation of the underlying property.

In step 414 the database server issues RU's created by a REA owner or developer. The step 414 issues the RU's to an investor, or multiple investors. Issuance of RU's is performed by the central database server in compliance with conditions of regional certifying authority (RCA), which includes unitization, determination of issue prices, settlement mechanism, and requisite documentation, Real Units. The issue value of an RU is based on valuation and certification done by the RCA. Developers may issue RU's reflecting the value of a portion of a REA, or the entire REA. There are multiple variables which determine the issue value of units. An RU issued for land is distinctly identifiable against unit issued for constructed property. An RU can be issued in any currency based on investor class and as per the rules and regulations.

Step 416 generates RU data and provides the data to all regional and central servers. Investors can access the RU data stored on the regional and central servers via the network. In step 418, RU's are issued as an initial offering and transferred to investors to facilitate trading of RU's.

Step 418 occurs after an initial offering in step 416. Step 418 transfers RU's to investors at a fair value. Factors determinative of a fair value include area, predicted REA appreciation, lease value, premium for conversion of use to most valuable use, etc. Step 420 enables the market to determine the market value of RU's through a Walrasian auction. In step 424 the system enables users to choose to exchange, settle or sell RU's.

Step 426 enables continued exchange of the RU's until expiry or settlement. Step 428 settles RU's against REA's, which comprise physical and real assets. Step 430 enables a titled REA owner to repurchase, redeem or buy-back RU's issued against the REA for cash at the market value.

There are a couple of models per assets class which will play role of an issuer. An investor could invest in only one category of units or all categories of units. A land owner can issue units based on his land to investor and unlock the value of his land. He can utilize proceeds in any activity and continue to enjoy the funds raised by delivering his committed returns. He can either repurchase the units or exchange them against units of any other property. A property developer would issue the units and use the proceeds for construction of premises. In case of commercial premises, which generate the lease income, he will continue to enjoy proceeds by delivering his committed annual interest rate to unit holder and in such case the RU's will be an open ended in nature. In case of residential premises, the unit will be of closed ended in nature and unit holders will have to compulsory settle them with developer. The settlement could be in actual possession of the property (equal to the units he owns) or against cash. Unit holder will not have an option to continue to hold the units unless otherwise accepted by the developer as that continues his annual commitment of interest charge. A developer may provide an option to unit holder to exchange the units of developed premises against new property under development or proposed to be developed. The RCA manages encumbrances, including any liens on property, and establishes clearing mechanism of RU's against real assets, etc. The RCA acts as guarantor.

In decision step 424, the RU holder has choices to exchange, settle, or sell the RU. During this decision step, RU's get modified in terms of quantity, value, settlement period based on development with RU owner. The RCA takes the appropriate corrective action. The RCA acts as the clearing agency. In step 430, the real estate owner buys-back the RU at market rate against cash.

Under RealEx format, the land owners can un-lock the economic value of the land by sharing the value of the REA with numerous investors by issue of RU's. These RU's can be open ended or closed ended based on the objective of the issuer.

Each real estate asset is unique in itself and its distinctness is also a vital factor in determining the real estate asset commercial value and possibilities of capital appreciation. Even every investor looks after each class of assets and every property in each class of assets with different perspective. Given this background, the RU's may attract new customers with their distinctness and potential for growth. Hence two units of different real estate class or two properties of same assets class will not be directly comparable. RU's issued by same developer in one type of assets class for properties in a same area could be comparable and competing with each other. The procedure for rating a developer, issue process of units, settlement/conversion of RU's are standardized across the country subject to local regulations, if any.

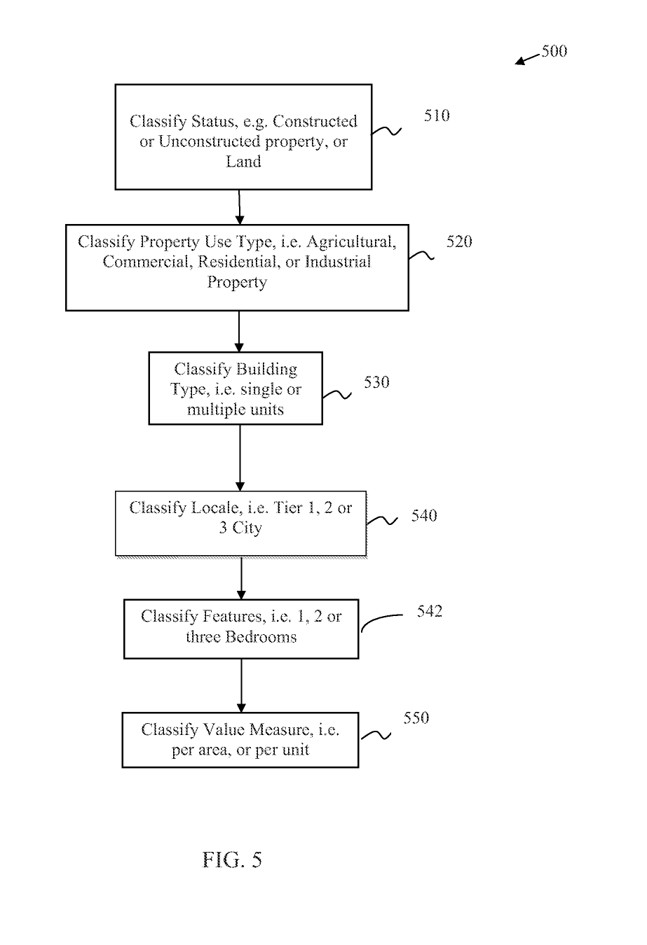

FIG. 5 shows an example flow diagram 500 for valuating an RU in accordance to an embodiment of the present invention. The flow diagram 500 begins with step 510 of classifying status, e.g. constructed or unconstructed property, or land. In this present example, the property class is constructed property having residential use. Next the step 520 classifies property use type on logical commercial criteria, such as industrial property, residential property, agricultural property, and commercial property. The step 530 classifies REA's based on type, i.e. single or multiple units, independent house, apartment in standalone building, and apartment in a satellite township. The number of units represents a sub-class common across REA's in a particular sub-class. In the present example, the sub-class is an apartment in standalone building.

In step 540 the locale is classified as a Tier 1, 2, or 3 city. Each tier is based on population range of the city. The step 542 classifies features such as the number of bedrooms, bathrooms, garage stalls and other criteria typically used when any REA is listed in a particular market.

There can be many tiers dependent on the development strategy. The different tiers can be areas identified by government development agency for future growth. Tiers are bifurcated by metros, non-metros cities, economically backward districts, draught circles within districts, districts heavily dependent on natural resources like rain, minerals, etc. Even though the base objective of all government policies specified for each of these tiers as ‘investment based growth’ the severity and tax sops offered along with these policies differ from tier to tier. They depend on requirement of each of these tier in addition to urgency of their alignment with mainstream growth trajectory. Objectives of such policies/tiers, for example, may be to divert investment to these areas and include economic and industrial activities. In the present example, tier 2 city is selected.

In step 550 a value measure is utilized to establish the value of the REA and resulting RU's. The step 550 takes into consideration the square footage of the property and the property type to establish the RU price. Alternatively, the per unit price for apartments is used, such as where apartments share a common area range.

RU prices ideally are market linked and depend on multiple underlying economic factors like tenure of RU, government regulations, proximity to industrial activity, connectivity to major cities of the state, port, airport, etc. The percentage contribution of each of these variables in determining the issue/trade price of RU will vary from state to state and city to city.

Investor confidence will be built up through statutory recognition of the exchange at central and state level; amendments in rules and regulations for recognition and tradability of economic interest of real estate assets; setting up of administrative machinery and transparent mechanism for evaluating, certifying the assets owner and grading and rating the RU before issue; transparent but regulated mechanism for settlement of units; and lowest possible documentation and transaction cost. Government should take initiative at initial stage with good credential assets owner for building investor confidence.

The objectives of certifying authorities are to create institutional framework of exchange that will build investor confidence, introduce and implement standardized procedures for evaluation, pricing, settlement, conversion of units, to grade the real estate properties, credit rating of assets owners, and act as regulator for investor protection etc. Involvement of RCA and central authority will help in broaden investor base as it scales up the scope of exchange through introduction of multiple products and their regulation.

Initially the authorities need to be a government agency until the exchange gets settled and the RealEX concept is well understood. The initial stages of development includes investor education, creating databank, standardization of evaluation parameters, etc. which will require amendments to certain key regulations. Over time, the administration of these agencies should be handed over to SEBI (Securities and Exchange Board of India, an India version of US SEC—Securities and Exchange Commission) like independent agency.

Units will be either open ended which means they may be purchased back by the issuer in a future date or will continue to be traded on exchange. The issuer is responsible to pay the pre-determined interest rate at every record date to the unit holder. The closed ended units will be due for settlement on pre-determined record date, where as per the terms of issue, the unit holder would get underlying assets/cash or new units. The investor will not have an option to continue to hold the closed ended units beyond its record date as the issuer will not be responsible to pay interest beyond record date. RCA should provide the settlement on a case by case basis.

A land owner who issues RU's to investors can give buy-back option to investor at the face value or delisting price as per the terms of issue. Alternatively, the land owner can buy-back the RU's to terminate the RU's. The price of the sum of RU's is ideally the Market Value of the underlying asset. The land owner can also give an option to the RU holder to take transfer the legal ownership of the land in proportion to the number of RU's surrendered by the investor.

The RU's of a residential property will be bought by the investor interested in possession of the property. These investors would either subscribe to the RU's at initial issue or buy the RU's from market as the project proceeds near to completion. The developer will not be allowed to sell the residential properties for which RU's have already been issued to investor, but the investor has to settle those units against actual delivery of equivalent properties. The investor can ask a customer to purchase the RU's from market to get the possession of the property, in case such customer does not have such units in hand.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Moreover, the above disclosure is not intended to limit the present invention. The scope of the present invention is defined by the claims.

I claim:

1. A method of creating a Real estate units reflective of the value of a real estate asset comprising the steps of:
recognizing the real estate asset type for each real estate asset;
classifying the real estate asset according to use;
unitizing the real estate asset as real estate units; and
valuating the real estate units to establish an initial offering price.

2. The method of claim 1, wherein the step of recognizing a real estate asset type includes determining whether the real estate asset is land, constructed property, or unconstructed property.

3. The method of claim 2, wherein the step of classifying the real estate asset includes determining the use as industrial, residential, agricultural or commercial.

4. The method of claim 3, wherein the step of unitizing the real estate asset establishes real estate units based on pre-determined criterion.

5. The method of claim 4, wherein the pre-determined criterion includes zoning.

6. The method of claim 5, wherein the pre-determined criterion includes a holding period of the real estate units, the cost of capital, and applicable inflationary trend.

7. A method of trading real estate units comprising the steps of:
compiling a plurality of real properties and establishing and valuating real estate units for the properties; wherein the real estate units includes:
categorizing the property into asset classes;
establishing multiple sub-classes, each with different level of completion and age factor;
determining a saleable area;
determining a present cycle of development for each property;
determining a related government policy attached to the property; and
establishing an initial price for the real estate units;
sharing the plurality of real estate units with a central database accessible by a plurality investors;
enabling the sale of the real estate units based on the valuation; and
trading at least some of the real estate units.

8. The method of claim 7, wherein the step of trading includes exchanging, settling, or selling the real estate units to other investors.

9. The method of claim 8, wherein the step of exchanging includes selling at least one real estate unit purchasing another real estate unit.

10. The method of claim 8, wherein each real estate units includes investment terms, and the step of settling the real estate units includes settling the investment terms.

11. The method of claim 8, further comprising termination of the real estate units through re-purchase in accordance with the investment terms.

12. The method of claim 8, wherein exchanging includes trading a defined number of real estate units for an equal number of different real estate units.

13. The method of claim 8, wherein exchanging includes selling includes trading a defined number of real estate units at market value for cash.

14. A system for trading real estate units having value comprising:
a central server accessible via a network, the server includes a processor, random memory, and data storage hardware;
the data storage hardware stores a database having data pertaining to a plurality of real estate assets and transforms the data to unitize real estate units reflective of the value by classifying the real estate assets into asset classes;
the server transforms data including a saleable area of each property and establishes an initial price for the real estate units based on the asset classes and saleable area; and
the server enables trading of the real estate units via the network.

15. The system of claim 14, wherein enabling trading includes publishing the price of the real estate units via the network.

16. The system of claim 15, wherein enabling trading includes receiving an order to purchase at least one of the real estate units via the network.

17. The system of claim 14, wherein the step of establishing an initial price for the real estate units includes utilizing the stored data to determine the Market Value, Value-in-use, Investment Value, Insurable Value or Liquidation Value.

18. The system of claim 15, wherein the price is an estimated market value of the real estate unit.

19. The system of claim 18, wherein the estimated market value is determined by utilizing at least one of: Cost Approach, the Comparative Approach, the Residual Approach or the Income Approach.

20. The system of claim 18, wherein the stored data includes comparable sales data and the market value is determined primarily by a comparative approach utilizing the comparable sales data.
